(19) United States
(12) Patent Application Publication
(10) Pub. No.: US 2009/0032762 A1
(43) Pub. Date: Feb. 5, 2009

(54) Flow Control Ball Valve

(75) Inventor: Marius Robert Junier, Houston, TX (US)

Correspondence Address: LUNDEEN & LUNDEEN, PLLC, PO BOX 131144, HOUSTON, TX, 77219-1144, US

(73) Assignee: MOGAS INDUSTRIES, INC., Houston, TX (US)

(21) Appl. No.: 11/877,457

(22) Filed: Oct. 23, 2007

Related U.S. Application Data
(60) Provisional application No. 60/953,942, filed on Aug. 3, 2007.

(51) Int. Cl. F16K 5/06; F16K 5/12

(52) U.S. Cl. 251/315.16; 137/539; 251/209

(57) ABSTRACT

A ball valve (10) is disclosed with an orifice (58) to control the flow of fluids in which the downstream seal (52) is never directly exposed to erosive wear from the fluid flow. The orifice (58) is only open in a limited range of the ball (42) rotation. Upon rotation of the ball (42) from the full closed position, the orifice starts to open on the outlet side (62) first and after the outlet orifice is fully open the orifice opens to the inlet side (60). The size of the opening on the inlet side (60) can be adjusted to control the flow rate of fluid through the orifice (58) in the ball (42). When closing the valve, the inlet side closes first and then the outlet side. The orifice (58) of the ball (42) thus passes the outlet seal (52) under no-flow conditions, and gross erosion of the outlet seal can be avoided.

### CROSS REFERENCE TO RELATED APPLICATION

This application claims the benefit of provisional application Ser. No. 60/953,942, filed Aug. 3, 2007.

### BACKGROUND OF THE INVENTION

The present invention relates to a flow control ball valve and a flow control method, and more particularly to such a valve and method that address the problem of reducing or avoiding wear on a primary seal.

Ball valves are used in many applications to control the flow of a fluid through a line or conduit. The typical ball valve has a flow bore through a rotary ball element, and primary and secondary seals, each having a seat ring spring-biased against the ball on opposite sides adjacent respective openings to the flow bore. The rings can be positioned around upstream and downstream flow passages. Usually the primary seal is disposed on the downstream or low pressure side of the ball element, and the secondary seal on the upstream or high pressure side. As the ball element is rotated, the openings move past the respective seat rings to increase or decrease the flow area in communication with upstream or downstream fluid flow passages. The flow through the ball valve can be controlled by increasing or decreasing the flow area. In the extreme rotary positions, the flow area can fully closed, i.e. zero or a low flow minimum, or fully open, i.e. the flow area is at a maximum which is generally equivalent to the cross sectional area of the flow bore through the ball element.

Some fluids can contain erosive solids that cause severe wear of the seals, especially as the openings to the flow bore are moved past the respective seat rings. Low flow conditions are particularly problematic because the pressure differential between the upstream and downstream flow passages into and from the valve are at a maximum, and the velocity of the fluid through the open flow area is likewise at a maximum and the erosive effect of suspended solids is at its greatest.

One particular application involving erosive flow control conditions is the catalyst fines discharge or dump system in the fluid catalytic cracking (FCC) unit in a refinery, for example. In an FCC reactor operating at elevated temperatures and pressures, catalyst is used to help break down larger hydrocarbon molecules into smaller hydrocarbon molecules, thereby producing “lighter” hydrocarbons for further processing. Over time, the catalyst in FCC units becomes coated with carbon, also known as coke, and ceases to efficiently break down the larger hydrocarbon molecules. The coked catalyst is transported to a regenerator reactor where it is heated with oxygen to burn off the coke and regenerate the catalyst. During normal operation and regeneration, some catalyst is broken into smaller particles, known as fines, and must be periodically or continuously replaced. A discharge piping system is used to periodically dump or continuously remove the catalyst fines. Because of the high temperatures and the erosive nature of catalyst fines, there remains a need in the art for a valve and method to reduce or avoid seal wear. Moreover, such valves are frequented by plugging problems when the entrained solids bridge or plug the flow passages, and also require a system or method to clear the flow passages from debris.

Extraction of catalyst fines has been performed using wear resistant choke tubes of a specific size selected to establish proper flow rates for the process requirements. The tube periodically plugs up with solids, requiring the line to be isolated and the tube removed and cleaned. Isolation is achieved by closing the upstream block valves, resulting in plant down time as well as added maintenance expenses. An alternate approach has been to use a valve in place of the choke tube, and to throttle and control the flow of catalyst with the valve. This system has the advantage of having the capability for adjusting the flow, however the internals of the throttling valve wear rapidly and are expensive to replace.

Various attempts to reduce wear in seals handling erosive fluids have included hard surfacing the wear surfaces and/or providing replaceable inserts or wear surfaces, as in U.S. Pat. No. 3,386,461 (Fisher); U.S. Pat. No. 3,707,161 (Crawford); U.S. Pat. No. 3,985,150 (Kindersley); U.S. Pat. No. 5,937,890 (Marandi); U.S. Pat. No. 10/352,329 (Green); and U.S. Pat. No. 7,219,877 (Mogas).

Other background references are of interest. U.S. Pat. No. 3,542,338 (Scaramucci) discloses a ball valve adapted for throttling having a bore treated or lined with an erosion resistant material. U.S. Pat. No. 3,794,071 (Scott) discloses a brake control valve device, wherein the device is equipped with a choke. U.S. Pat. No. 5,205,533 (Berchem) discloses a ball valve having a ceramic coated passage and a restriction within the ball, wherein the bore within the ball narrows, producing a larger outlet bore diameter than the inlet bore. U.S. Pat. No. 5,551,467 (Booth) and U.S. Pat. No 5,593,135 (Lester) disclose ball valves for precise throttling of fluid through the valve, achieving near linear performance in controlling the flow of the fluid. U.S. Pat. No. 6,260,820 (Chowdhury) discloses a valve and method for producing a valve. U.S. Pat. No. 6,412,756 (Hayduk) discloses a gas tight ball valve for use with granular material. U.S. Pat. No. 6,540,206 (Guerra) discloses a bi-directional ball valve for use with cold gases. U.S. Pat. No. 6,698,712 (Milberger) discloses a ball valve for use in oil and gas production systems, having a vent bore for the venting of pressure.

### SUMMARY OF THE INVENTION

The present invention can provide a flow control ball valve and method wherein one of the seals, e.g. a primary or downstream seal, has no or limited direct exposure to high velocity fluid flow in the flow bore or orifice. In one embodiment, the ball valve can use an off-center flow bore through the ball wherein the openings from the flow bore alternatingly or sequentially move past the respectively adjacent seals. In this manner, in an intermediate position when a first one of the openings is fully closed to prevent any fluid flow, a second one of the openings can be moved past the respective seal and be selectively opened or closed; and when the first one of the openings forms an orifice with its adjacent seal, the second opening can be spaced away from its adjacent seal to direct any fluid flow jet away from the seal. In addition, in one embodiment the flow bore in the valve element can be purged in the intermediate position via a purge fluid inlet to an annulus between the ball element and a valve housing, wherein the annulus can be in communication with the first opening.

In one embodiment, the invention provides a flow control ball valve, including a ball element sealingly disposed within a fluid flow passage, and a flow bore through the ball element having opposite first and second ends rotatable with the ball element. The ball valve can have a full closed position wherein the first and second ends of the flow bore are sealed from the fluid flow passage. The ball valve can have an intermediate closed position wherein the second end is selectively in partial or full fluid communication with the fluid flow passage and the first end is sealed from the fluid flow passage. The ball valve can also have a flow control position wherein the second end is in full fluid communication with the fluid flow passage and the first end is selectively in partial or full fluid communication with the fluid flow passage.

In an embodiment, the flow control ball valve can further include a purge connection in fluid communication with the flow bore via the first end in the intermediate closed position.

In an embodiment, the flow bore can include first and second portions adjacent the respective first and second openings, wherein the second portion can have a larger cross sectional area relative to a cross sectional area of the first portion. The cross section of the second portion of the flow bore can be circular. The cross section of the first portion of the flow bore can taper from a maximum width at an outer side to a minimum width at an inner side. In an embodiment, the cross section of the first portion of the flow bore can be trapezoidal.

In an embodiment, the flow control ball valve can have an orientation wherein the flow bore slopes downwardly toward the second opening in the intermediate closed position. The flow bore can be offset laterally from a longitudinal flow axis.

In another aspect, the invention provides a valve apparatus including a housing having first and second fluid flow passages, a flow control element slideable in the housing, and a flow bore through the flow control element having first and second spaced-apart openings to a surface of the flow control element. A first seal can be disposed between the flow control element and the housing adjacent to the first opening, and a second seal between the flow control element and the housing adjacent to the second opening. The valve apparatus can have (1) a full closed mode wherein the first and second seals are respectively disposed between the first and second openings and the first and second flow passages, (2) an intermediate closed mode wherein the first seal is disposed between the first opening and the first flow passage when the second opening and the second seal are in contact to provide fluid communication between the second flow passage and the flow bore, and (3) an open flow mode wherein the second opening is always spaced away from the seal to provide fluid communication between the second flow passage and the flow bore when the flow bore is in fluid communication with the first flow passage.

In an embodiment, the valve apparatus can have a purge connection on the housing for fluid communication with a fluid space defined by an inner surface of the housing spaced from an outer surface of the flow control element between the first and second seals, wherein the fluid space is in communication with the flow bore via the first opening in a purge mode, and wherein the second seal is disposed between the second opening and the second flow passage and the first flow passage is in fluid communication with the flow bore via the first opening.

In an embodiment of the valve apparatus, the flow control element can be a ball. Alternatively or additionally, the flow control element can be slideably rotatable in the housing and/or have an at least partially spherical surface for cooperation with the seals. The flow bore can have first and second portions adjacent the respective first and second openings, wherein the first portion has a smaller transverse cross sectional area with respect to a transverse cross sectional area of the second portion. The cross section of the first portion of the flow bore can be circular. The cross section of the first portion of the flow bore can taper from a maximum transverse width at an outer side to a minimum transverse width at an inner side. The cross section of the first portion of the flow bore can be trapezoidal, for example.

In another embodiment of the valve apparatus, the first and second seals can be disposed circumferentially about the respective first and second fluid flow passages. The first and second fluid flow passages can have a vertical orientation with the second fluid flow passage below the first fluid flow passage, or an orientation wherein the flow bore slopes downwardly toward the second opening in the intermediate closed mode. The flow bore can be offset laterally from a longitudinal flow axis.

In another aspect, the present invention provides a ball valve that can have a rotatable ball element disposed between upstream and downstream flow passages, and upstream and downstream circumferential seals at a spherical surface of the ball element. The upstream and downstream seals can circumscribe the respective upstream and downstream flow passages. The ball valve can have a longitudinal flow bore through the ball element from an upstream opening at the surface of the ball element to a downstream opening at the surface of the ball element to provide fluid communication between the upstream and downstream flow passages via the flow bore when the ball element is rotated to an open position. The upstream opening can have a path of rotation from the open position in fluid communication with the upstream passage, through a flow control position across the upstream seal, to a closed position opposite the upstream seal. The downstream opening can have a path of rotation from the open position spaced from the downstream seal, through an intermediate position in contact with the downstream seal, to a closed position opposite the downstream seal. The upstream and downstream openings can be coordinated to maintain the downstream opening in the open position when the upstream opening is in the flow control position, and the upstream opening in the closed position when the downstream opening is in the intermediate position.

In an embodiment, the ball valve can include a purge connection in fluid communication with a fluid space between the upstream and downstream seals. The fluid space can be in communication with the flow bore via the upstream opening when the upstream opening is in the closed position and the downstream opening is in the open position.

In an embodiment of the ball valve, the flow bore can include upstream and downstream portions adjacent the respective upstream and downstream openings, wherein the downstream portion can have a larger transverse cross sectional area relative to a transverse cross sectional area of the upstream portion. The cross section of the downstream portion of the flow bore can be circular. The cross section of the upstream portion of the flow bore can taper from a maximum width at an outer side to a minimum width at an inner side. The cross section of the upstream portion of the flow bore can be trapezoidal. The downstream flow passage can have a vertical orientation and depend from the ball element. The ball valve can have an orientation wherein the flow bore slopes downwardly toward the downstream opening in the intermediate position. The flow bore can be offset laterally from a longitudinal flow axis.

In another aspect, the invention provides a method of controlling fluid flow through a flow passage comprising a ball valve with a ball element sealingly disposed in the flow passage and a flow bore through the ball element having opposite first and second ends rotatable with the ball element. The method can include: (1) rotating the ball element to a full closed position wherein the first and second ends of the flow bore are sealed from the fluid flow passage; (2) rotating the ball element to an intermediate closed position wherein the second end is selectively in partial or full fluid communication with the fluid flow passage and the first end is sealed from the fluid flow passage; and (3) rotating the ball element to a flow control position wherein the second end is in full fluid communication with the fluid flow passage and the first end is selectively in partial or full fluid communication with the fluid flow passage. In an embodiment, the method can include at least periodically purging the flow bore with a purge fluid introduced via the first end when the ball element has been rotated to the intermediate closed position.

A further aspect of the invention can include a method for the extraction of catalyst from an FCC regeneration unit. The method can include: (1) extracting catalyst through a conduit exiting a catalyst regeneration unit; (2) positioning the flow control ball valve described above in the conduit; (3) positioning the flow control ball valve in the flow control position for the extraction of catalyst; (4) positioning the flow control ball valve in the full closed position for isolation; and (5) passing the flow control ball valve through the intermediate position between the flow control and full closed positions. The method can also include, in an embodiment, purging the flow bore via the first end in the intermediate closed position.

### BRIEF DESCRIPTION OF THE DRAWINGS

FIG. 1 is an end view of a flow control ball valve according to an embodiment of the present invention, as seen from the inlet or upstream end in the full open position corresponding to 90 degrees of rotation of the ball.

FIG. 2 is a side sectional view of the flow control ball valve of FIG. 1 as seen along the lines 2-2.

FIG. 3 is a sectional plan view of the flow control ball valve of FIG. 1 as seen along the lines 3-3.

FIG. 4 is a schematic of the flow control ball valve of FIG. 3 wherein the ball has been rotated towards the closed position to just begin entering the flow control position where the inlet opening to the flow bore is partially occluded by the inlet seat ring and the outlet opening to the flow bore is spaced away from the outlet seat ring.

FIG. 5 is a schematic of the flow control ball valve of FIG. 4 wherein the ball has been further rotated towards the closed position where the inlet opening to the flow bore is just fully occluded by the inlet seat ring but the outlet opening from the flow bore is still fully open to the outlet flow passage.

FIG. 6 is a schematic of the flow control ball valve of FIG. 5 wherein the ball has been further rotated to the full closed position corresponding to 0 degrees of rotation of the ball.

FIG. 7 is a schematic diagram of an FCC unit incorporating the flow control ball valve of FIGS. 1-6 according to an embodiment of the invention.

### DETAILED DESCRIPTION

The present invention in one embodiment can provide a ball valve apparatus with an orifice to control the flow of fluids wherein the downstream seal is never exposed directly to substantial erosion from the fluid flow. A flow control ball valve can incorporate a staggered opening and closing of inlet and outlet orifices in the ball, wherein the outlet orifice communicates with the flow passage first upon opening, and upon closing the valve the inlet orifice is closed first when the valve is rotated toward the closed orientation for flow control. This configuration allows the outlet orifice to be selectively opened or closed in a low- or no-flow condition to minimize erosion and wear at the outlet seal.

The valve of the present invention can control the flow rate of a continuous flow of fluids and solids as required for normal process operations, via a variable orifice. During normal operation in a process having solids flow, such as in a fluidized catalytic cracking unit, or FCC unit, for example, the conduit upstream of the ball valve can become plugged with solids. When this occurs, the ball valve of the present invention can be rotated to a full open position, or blowdown position, thereby allowing the solids to be flushed out and continuous flow can be re-established. Solids can also be purged from the housing and flow bore via a purge connection that can introduce a purge fluid into the flow bore from the upstream end and into the downstream flow passage.

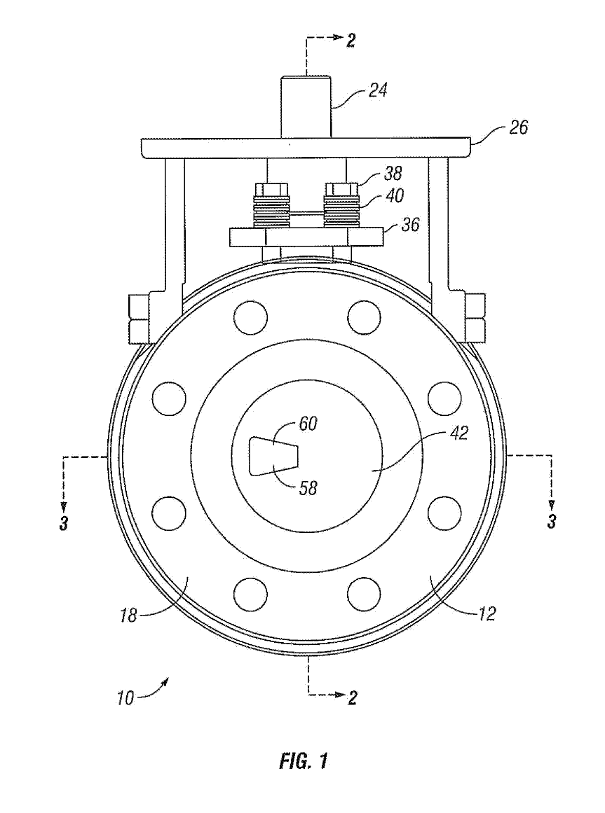

The flow control ball valve 10 according to one embodiment of the present invention is depicted in FIGS. 1-6, where like parts are represented by like numerals. The body of the valve 10 can be of two-piece construction from metal or other suitable material, having upstream body portion 12 and downstream body portion 14. As used herein, the terms “upstream,” “inlet,” “high pressure” and “first” are equivalent, as are the terms “downstream,” “outlet,” “low pressure” and “second,” and are used for reference to a preferred flow orientation; it is to be understood that the valve is not necessarily limited to this particular flow orientation, to which reference is made herein for the purpose of illustration and convenience.

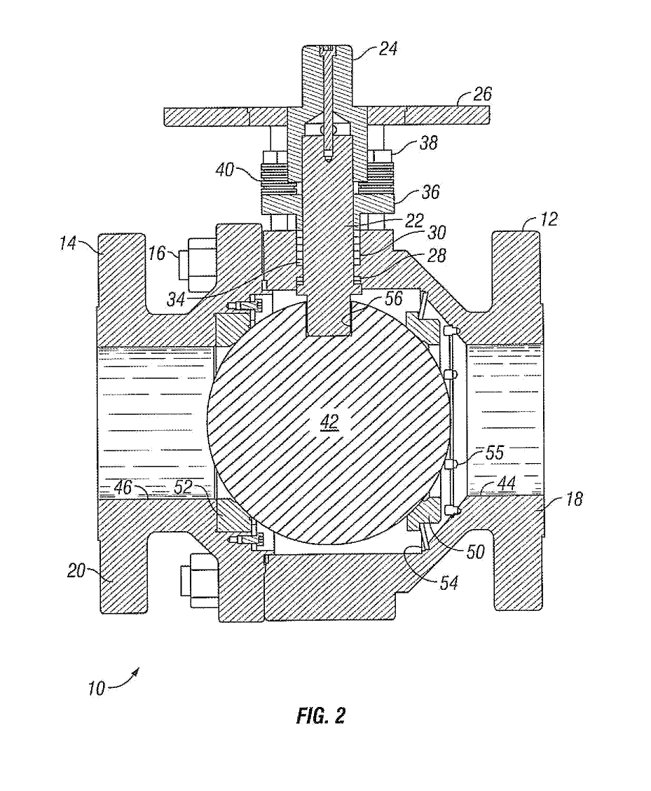

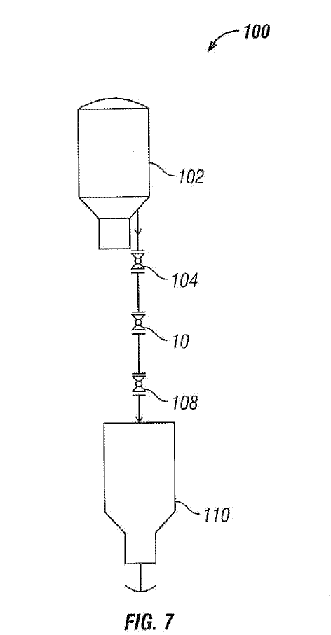

Body members 12 and 14 can be connected together with bolts 16, as illustrated in FIGS. 2-6. End connections 18 and 20 can allow for connection of the valve 10 to upstream and downstream tubing, piping, or other processes (see FIG. 7, for example), respectively, and can be flanged or screwed type connections as are standard in the industry.

As best shown in FIG. 2, ball valve 10 can have a stem 22 and stem connector 24, which can be conventionally adapted to connect to a valve handle or a valve positioner (not shown) via actuator mounting flange 26. The mounting flange 26 can be bolted to the upstream body portion 12 and optionally thermally compensated as disclosed in US 2007-0177933. The valve 10 can also include stem bearings 28, packing rings 30, upper and lower anti-extrusion rings 32, 34, gland follower 36, bolts 38 and live loading springs 40.

The upstream and downstream body members 12 and 14 can have bores 44 and 46 which can form a flow path (an inlet and outlet, respectively) through valve 10. The bores 44, 46 can be provided with a hard facing, for example, with a cobalt-chromium-tungsten alloy available under the trade designation STELLITE. When joined, body members 12 and 14 can form an interior chamber to receive the ball member 42. Seat rings 50 and 52, in conjunction with spring 54, can form seals between an outer surface of the ball member 42 and respective inner surfaces of body members 12, 14. Retainer ring 53 can be secured by screws to hold seat ring 50 in place. Stop ring 55 can be disposed to prevent over-travel of the seat ring 50 and inversion of the spring 54. Ball member 42 can include stem connection detent 56 of a non-circular cross section to receive a distal end of the stem 22 of matching geometry to operatively connect the ball member 36 to stem 22 for rotation via the valve handle or other positioner.

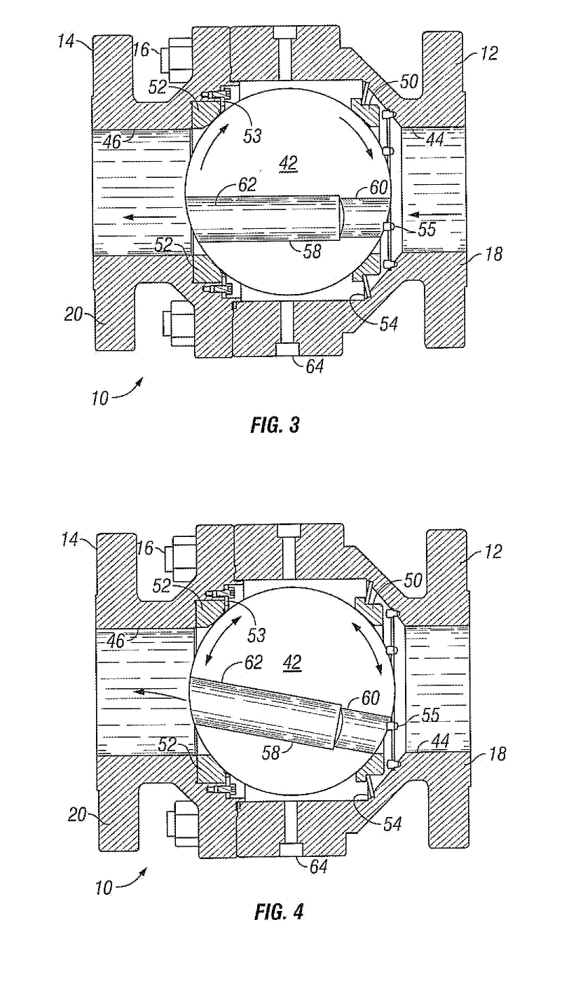

As best seen in FIGS. 3-6, a flow bore 58 is provided through the ball member 42, which can include an upstream section 60 and a downstream section 62. The upstream section 60 can have a trapezoidal cross section formed by cutting, for example, using electrical discharge machining. The downstream section 62 can have a circular cross section larger than the upstream section and can be formed by drilling, for example.

FIG. 3 shows the ball member 42 rotated to the full open position or 90 degrees where the flow bore 58 is aligned with the longitudinal flow axis to permit full communication between the inlet and outlet bores 44, 46. The flow bore 58 can be slightly offset from the longitudinal axis so that upon rotation of the ball member 42 the opening from the upstream section 60 has a shorter path to reach the seat ring 50 than the opening from the downstream section 62 to reach the seat ring 52. In the full open position, fluid flow is directed past the inlet seal comprising the spring 54 and seat ring 50 into the inlet section 60 of the flow bore 58, and then through the outlet section 62 and into the downstream bore 46. The larger cross sectional area of the outlet section 62 can facilitate expansion of the fluid where the fluid is compressible, e.g. a gas.

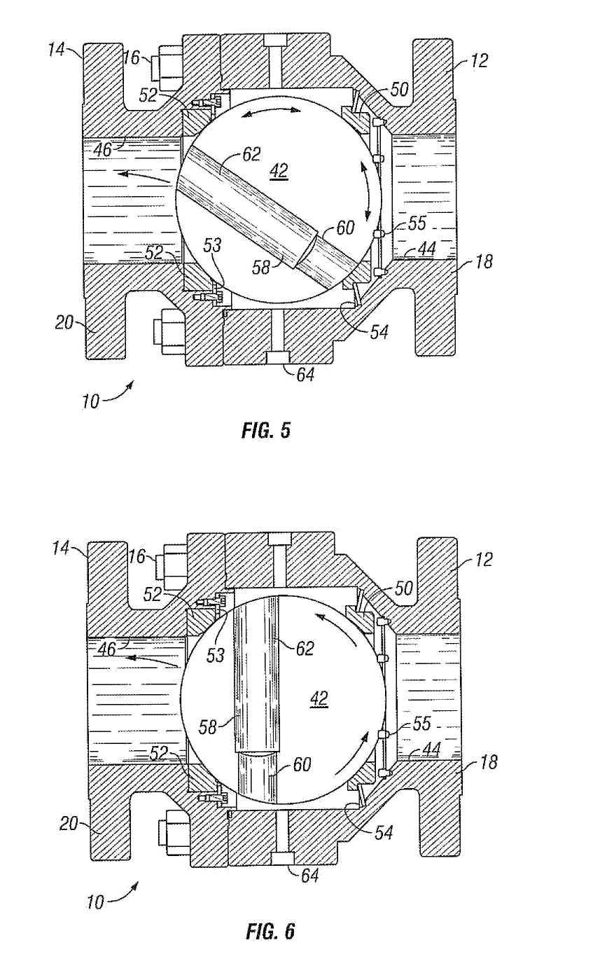

Rotating the ball member 42 from the full open position toward the closed position as shown in FIG. 4 initiates a flow control mode where the opening into the inlet section 60 cooperates with the seat ring 50 to adjust the effective size of the flow orifice at the entry to the flow bore 58. Further rotation of the ball member 42 toward the closed position reduces the effective orifice size and eventually closes off the orifice entirely, as shown in FIG. 5. In the FIG. 4 embodiment, the valve can be effectively full open, for example, at 78 degrees of rotation; whereas in the FIG. 5 embodiment, the valve can be effectively closed to fluid flow entering the opening into the inlet section 60, for example, at 55 degrees rotation. Between 55 and 78 degrees of rotation, in this example, the opening to the inlet section 60 is adjusted to control the fluid flow rate through the valve 10.

In the flow control mode, including both extremes of the flow control mode, corresponding to rotation of the ball member 42 between the positions shown in FIGS. 4 and 5, the opening from the outlet section 62 of the flow bore 58 can be spaced away from the seat ring 52 to avoid direct impingement of a fluid jet onto the sealing surfaces of the seat ring 52. Moreover, the larger cross sectional area of the outlet section 62 relative to the inlet orifice can reduce the outlet fluid velocity in the flow control mode.

Further rotation of the ball member 42 from the intermediate position (FIG. 5) toward the closed or zero degree position of FIG. 6 moves the opening from the outlet section 62 of the flow passage 58 in a path of rotation past the seat ring 52, referred to herein as an outlet transition mode. Since the inlet opening is closed, however, there is normally no fluid flow, except as may result from leakage through the inlet seal or purge fluid, during opening and closing of the outlet section 62 and thus no erosion or wear from fluid flow in the flow control mode. This is a beneficial arrangement because the integrity of the downstream seal can be preserved for a longer period of time, and the downstream seal is preferably the primary pressure seal in a zero flow or full closed position.

The trapezoidal cross section of the inlet section 60 can facilitate linearization of the control characteristics of the valve 10. When the valve is first cracked open, the opposite non-parallel sides of the inlet section 60 are relatively close together, but the distance increases as the ball member 42 is rotated more toward the full open position. Because erosion from high velocity fluid, which may contain entrained particles, is greatest at the seat ring 50 and the ball member 42, especially at the opening to the inlet section 60 of the flow bore 58, these can be made of and/or surfaced with a hard, erosion resistant material. Moreover, the upstream seal is secondary to the downstream seal, and thus some limited leakage of the upstream seal can be tolerated, e.g. at the sealing surfaces of the seat ring 50 against the ball member 42 and/or past the spring 54. Further, the life of the seat ring 50 can be extended by periodically rotating the seat ring 50 after wear begins to develop to position the area of wear out of the path of rotation of the opening to the inlet section 60.

In the embodiment illustrated in FIGS. 1-6, the flow control ball valve 10 can have the following operating modes or positions shown in Table 1:

TABLE 1
Flow control ball valve operating positions.

| | Approximate | Opening | |
|---|---|---|---|
| | rotation of ball | to flow | Opening from |
| | member 42 | bore inlet | flow bore outlet |
| Mode (Fig.) | (degrees) | section 60 | section 62 |
| Full closed | 0-30 | Closed | Closed |
| (FIG. 6) | | | |
| Outlet transition | >30 | Closed | Partially open |
| (FIG. 5 [symbol] FIG. 6) | | | |
| Intermediate | <55 | Closed | Open |
| (Purge) (FIG. 5) | | | |
| Flow control | 55-78 | Partially open | Open |
| (Inlet transition) | | | |
| (FIG. 4 [symbol] FIG. 5) | | | |
| Full open (FIG. 3) | 78-90 | Open | Open |

The ball valve 10 can also, if desired, have one or more purge taps 64 preferably formed in the upstream body member 12. The tap 64 can provide an entry point for a purge fluid around the ball member 42 into an annulus between the seat rings 50, 52. In the intermediate position (FIG. 5), for example, a purge fluid such as high pressure steam, air or nitrogen, etc., can be periodically blasted or continuously bled into the valve 10 via the purge tap 64 to help clear debris from the annulus, through the flow bore 58 via the inlet section 60, and into the downstream bore 46.

The ball valve 10 of the present invention can be used in many varied processes, and can be especially useful in processes involving solids flow. For example, the ball valve of the present invention can be used in the continuous extraction of catalyst from an FCC unit 100, as shown in FIG. 7. The spent, or coked, catalyst of an FCC unit is regenerated in a regenerator 102, as is well known by those in the art. During regeneration, some catalyst breaks into smaller pieces, known as fines, which must periodically be removed from the system. The fines can pass through a dump valve 104, through the flow control ball valve 10 of the present invention, through an isolation valve 108, to the spent catalyst hopper 110. Valves 104 and 108 can be ball or gate valves, but preferably the dump valve 104 is a ball valve, and the isolation valve 108 is preferably a gate valve.

During normal operations, continuous catalyst extraction can occur through valve 10, which can be in the flow control position for metering catalyst withdrawal. If the piping upstream of the valve 10 of the present invention becomes clogged during service, the obstructions can be cleared by cycling the continuous catalyst extraction valve 10 between the closed (or intermediate) and open positions, generating a relatively high pressure differential and fluid flow rate to wash through the flow bore and remove existing obstructions. If available, a purge fluid can also be blasted through the valve 10 in the intermediate position. Once the conduit has been cleared, the valve 10 can be rotated back to the flow control position, and normal, continuous extraction of the catalyst can be restored.

It will be seen that a ball valve apparatus and method suitable for clearing upstream obstructions in the extraction of catalyst have been provided. The invention is described above in reference to specific embodiments for illustrative and non-limiting purposes. Various modifications and variations will occur to the skilled artisan in view thereof. It is intended that all such modifications and variations within the scope and spirit of the appended claims be embraced thereby.

What is claimed is:

1. A flow control ball valve, comprising:
a ball element sealingly disposed within a fluid flow passage;
a flow bore through the ball element having opposite first and second ends rotatable with the ball element;
a full closed position wherein the first and second ends of the flow bore are sealed from the fluid flow passage;
an intermediate closed position wherein the first end is sealed from the fluid flow passage and the second end is selectively in partial or full fluid communication with the fluid flow passage; and
a flow control position wherein the first end is selectively in partial or full fluid communication with the fluid flow passage and the second end is in full fluid communication with the fluid flow passage.

2. The flow control ball valve of claim 1, further comprising a purge connection in fluid communication with the flow bore via the second end in the intermediate closed position.

3. The flow control ball valve of claim 1, wherein the flow bore comprises first and second portions adjacent the respective first and second openings, wherein the second portion has a larger cross sectional area relative to a cross sectional area of the first portion.

4. The flow control ball valve of claim 3, wherein the cross section of the second portion of the flow bore is circular.

5. The flow control ball valve of claim 4, wherein the cross section of the first portion of the flow bore tapers from a maximum width at an outer side to a minimum width at an inner side.

6. The flow control ball valve of claim 5, wherein the cross section of the first portion of the flow bore is trapezoidal.

7. The flow control ball valve of claim 1 comprising an orientation wherein the flow bore slopes downwardly toward the second opening in the intermediate closed position.

8. The flow control ball valve of claim 1 wherein the flow bore is offset laterally from a longitudinal flow axis.

9. A valve apparatus, comprising:
a housing having first and second fluid flow passages;
a flow control element slideable in the housing;
a flow bore through the flow control element having first and second spaced-apart openings to a surface of the flow control element;
a first seal disposed between the flow control element and the housing adjacent to the first opening;
a second seal disposed between the flow control element and the housing adjacent to the second opening;
a full closed mode wherein the first and second seals are respectively disposed between the first and second openings and the first and second flow passages;
an intermediate closed mode wherein the first seal is disposed between the first opening and the first flow passage when the second opening and the second seal are in contact to provide fluid communication between the second flow passage and the flow bore; and
an open flow mode wherein the second opening is spaced away from the seal to provide fluid communication between the second flow passage and the flow bore when the flow bore is in fluid communication with the first flow passage.

10. The valve apparatus of claim 9, further comprising a purge connection on the housing for fluid communication with a fluid space defined by an inner surface of the housing spaced from an outer surface of the flow control element between the first and second seals wherein the fluid space is in communication with the flow bore via the first opening in a purge mode wherein the first seal is disposed between the first opening and the first flow passage and the second flow passage is in fluid communication with the flow bore via the second opening.

11. The valve apparatus of claim 9, wherein the flow control element is rotatable in the housing.

12. The valve apparatus of claim 11, wherein the flow control element comprises an at least partially spherical surface for cooperation with the seals.

13. The valve apparatus of claim 9, wherein the flow bore comprises first and second portions adjacent the respective first and second openings, wherein the first portion has a smaller transverse cross sectional area with respect to a transverse cross sectional area of the second portion.

14. The valve apparatus of claim 9 wherein the first and second seals are disposed circumferentially about the respective first and second fluid flow passages.

15. The valve apparatus of claim 9 comprising an orientation wherein the flow bore slopes downwardly toward the second opening in the intermediate closed mode.

16. The valve apparatus of claim 9 wherein the flow bore is offset laterally from a longitudinal flow axis.

17. A ball valve, comprising:
a rotatable ball element disposed between upstream and downstream flow passages;
upstream and downstream circumferential seals at a spherical surface of the ball element, wherein the upstream and downstream seals circumscribe the respective upstream and downstream flow passages;
a longitudinal flow bore through the ball element from an upstream opening at the surface of the ball element to a downstream opening at the surface of the ball element to provide fluid communication between the upstream and downstream flow passages via the flow bore when the ball element is rotated to an open position;
the upstream opening having a path of rotation from the open position in fluid communication with the upstream passage, through a flow control position across the upstream seal, to a closed position opposite the upstream seal;
the downstream opening having a path of rotation from the open position spaced from the downstream seal, through an intermediate position in contact with the downstream seal, to a closed position opposite the downstream seal;
wherein the upstream and downstream openings are coordinated to maintain the downstream opening in the open position when the upstream opening is in the flow control position, and the upstream opening in the closed position when the downstream opening is in the intermediate position.

18. The ball valve of claim 17, further comprising a purge connection in fluid communication with a fluid space between the upstream and downstream seals wherein the fluid space is in communication with the flow bore via the upstream opening when the upstream opening is in the closed position and the downstream opening is in the open position.

19. The ball valve of claim 18, wherein the flow bore comprises upstream and downstream portions adjacent the respective upstream and downstream openings, wherein the downstream portion has a larger transverse cross sectional area relative to a transverse cross sectional area of the upstream portion.

20. The ball valve of claim 19, wherein the cross section of the upstream portion of the flow bore tapers from a maximum width at an outer side to a minimum width at an inner side.

21. The ball valve of claim 20, wherein the cross section of the upstream portion of the flow bore is trapezoidal.

22. A method of controlling fluid flow through a flow passage comprising a ball valve with a ball element sealingly disposed in the flow passage and a flow bore through the ball element having opposite first and second ends rotatable with the ball element, comprising:
rotating the ball element to a full closed position wherein the first and second ends of the flow bore are sealed from the fluid flow passage;
rotating the ball element to an intermediate closed position wherein the first end is sealed from the fluid flow passage and the second end is selectively in partial or full fluid communication with the fluid flow passage; and
rotating the ball element to a flow control position wherein the first end is selectively in partial or full fluid communication with the fluid flow passage and the second end is in full fluid communication with the fluid flow passage.

23. The method of claim 22, wherein rotating the ball element to the intermediate closed position further comprises at least periodically purging the flow bore with a purge fluid introduced via the first end.

24. A method for the extraction of catalyst from an FCC regeneration unit, comprising:
extracting catalyst through a conduit exiting a catalyst regeneration unit;
positioning the flow control ball valve of claim 18 in the conduit;
positioning the flow control ball valve in the flow control position for the extraction of catalyst;
positioning the flow control ball valve in the full closed position for isolation; and
moving the flow control ball valve through the intermediate position between the flow control and full closed positions.

25. The method of claim 24 further comprising purging the flow bore via the first end in the intermediate closed position.
